(19) United States
(12) Patent Application Publication
(10) Pub. No.: US 2005/0119863 A1
(43) Pub. Date: Jun. 2, 2005

(54) Manufacturing monitoring system and methods for determining efficiency

(76) Inventors: John T. Buikema, Aurora, IL (US); James E. Engstrom, Cedar Rapids, IA (US); Joel L. Jacobs, Cedar Rapids, IA (US); Luke J. Meierotto, Marion, IA (US); Timothy A. Munger, Solon, IA (US); Susan M. Rollinger, Shellsburg, IA (US); Norman P. Russell, Cedar Rapids, IA (US); Gretchen T. Talley, Naperville, IL (US)

Correspondence Address: RYNDAK & SURI, 30 NORTH LASALLE STREET, SUITE 2630, CHICAGO, IL, 60602, US

(21) Appl. No.: 10/636,011

(22) Filed: Aug. 7, 2003

(51) Int. Cl. G06F 15/00

(52) U.S. Cl. 702/188

(57) ABSTRACT

A manufacturing monitoring system and related methods for determining the efficiency of a production plant, of an assembly or process line, or of the components of the assembly or process line. Data relating to the efficiency of the plant, production line, or components of the production line are gathered, such as one or more of unit output values, downtime occurrences, downtime duration, downtime incident codes, downtime categorization, action items, minutes ran, hours scheduled, capable rate, actual output, idle time, total time and waste analysis values. The gathered data is stored and production efficiencies are calculated based upon the gathered data. The results are communicated, such as by the Internet or intranet, to computers, databases, servers or terminals. Related methods are also disclosed.

### FIELD OF THE INVENTION

The present invention relates generally to apparatus and processes for determining efficiency, and, more particularly, to apparatus and methods for determining the efficiency of a production plant, an assembly or process line, or the components of the assembly or process line.

### BACKGROUND OF THE INVENTION

In the manufacturing industry, there are two types of manufacturing, discrete and process manufacturing. In a discrete manufacturing system, a unit or good is typically produced from other components by means of an assembly line. These assembly lines are usually highly automated, but might also include human workers and general-purpose manufacturing equipment. Often manufacturing plants will have several different assembly lines running simultaneously, either continuously producing the same product or several different products.

On the other hand, a process manufacturing system is based on the continuous flow of materials from one stage to another. In this method, usually the initial input is chemically or physically changed at each stage of manufacturing. Process manufacturing lines are also highly automated and process manufacturing plants will often have several process lines producing the same product or several different products.

Regardless of the type production line, improving the efficiency of the manufacturing process results in an increase of profits for the manufacturer. As a result, manufacturers constantly attempt to modify their assembly and process lines to increase their efficiency. With the advent of computers, there have been several developments in the field of automated monitoring systems. Manufacturers have employed this computer technology in order to more accurately determine the efficiency of their manufacturing process. Nevertheless, these systems still have several disadvantages that prevent accurate reporting and the gathering of detailed information pertaining to the efficiency of an assembly or process line.

In certain manufacturing monitoring systems, only the efficiency of the entire plant is calculated rather than individual product lines. These systems also record downtimes due to maintenance or equipment failures and reductions in plant efficiency. However, these systems cannot point out specific sources of inefficiency. By monitoring the efficiencies of different components of a product line, a component that decreases the efficiency of the product line can be identified, replaced, or modified to improve its efficiency and that of the production line.

Moreover, these systems and methods used to track efficiency are inaccurate due to user error. Often, data from many sources would have to be gathered by a product line operator and then transcribed into a central database at a later time by someone else. Whereas, a system that allowed for different operators to enter data while monitoring different areas of the product line would usually correct or avoid these problems. Operators would then be a position to detect and correct mistakes made after they entered the values relating to efficiency.

Other manufacturing monitoring systems were developed to offer solutions to change the configuration of an assembly or process line based on the time required for production and on a database of known manufacturing methods. These systems have many shortcomings. First, these systems do not provide an effective means for determining the efficiency of the product line. Additionally, these monitoring systems do not track the efficiency of new components to determine whether the changes made to the production line successfully improved the efficiency. These systems frequently contain extraneous information and require the user or operator to enter irrelevant information, not relating to improving efficiency.

Another solution to increase the efficiency of a production line is a monitoring system that aids in the planning for production line changeovers. The goals of these systems are limited to reducing downtime and preventing long-term work stoppages of a production line. However, these systems cannot determine the current efficiency of a production line or track the changes in efficiency after a production line changeover.

Thus, traditional models of monitoring a production line or the overall efficiency of a plant are incapable of providing the real-time efficiency analysis needed to improve the efficiency of individual production lines. Consequently, there is a need for a system that assesses and tracks the components of a process line or an assembly line and overcomes at the least some of the disadvantages of these prior art systems.

Accordingly, it is a general object of the present invention to provide a distributed system that can gather data about the state of the manufacturing equipment and its sub-components being utilized on a plurality of different assembly or process lines and locations.

Yet another object of the present invention is to determine the efficiency of the manufacturing equipment or machinery based on the gathered values.

A further object of the present invention is to provide an organized method for storing and displaying the information gathered and calculated by the system.

A still further object of the present invention is to provide a system and a method that can aid individuals in the implementation of a manufacturing initiative for optimizing the effectiveness of manufacturing equipment.

Some or all of the objects and/or aspects of the invention referred to herein can be used in full or partial combination.

### BRIEF SUMMARY OF THE INVENTION

This invention is directed to manufacturing monitoring systems and methods for determining the efficiency of a production plant, of an assembly or a continuous process system or process line or of components of the assembly or process line.

In one embodiment, data relating to the efficiency of the plant, production line, or components of the production line are gathered, such as unit output values, downtime occurrences, downtime duration, downtime incident codes, downtime categorization, action items, minutes ran, hours scheduled, capable rate, actual output, idle time, total time and waste analysis values. The gathered data are stored and production efficiencies are calculated based upon the gathered data. The results are communicated, such as by the Internet or an intranet, to other parts of the system, including to computers, databases, servers or terminals.

Methods for determining the efficiency of the manufacturing plant, assembly or process line, or of components of the assembly or process line include gathering data relating to the efficiency of interest, such as of the plant, line or components of the line. This data preferably include one or more of the following types of data: unit output values, downtime occurrences, downtime duration, downtime incident codes, downtime categorization, action items, minutes ran, hours scheduled, capable rate, actual output, idle time, total time and waste analysis values. The gathered data is stored and the efficiencies are calculated based upon the gathered data. The calculated data are communicated, such as via the Internet or an intranet, to other parts of the monitoring system, including to computers, terminals, servers and databases. The gathered and calculated data can also be displayed on a monitor or other viewable display.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the figures in which like reference numerals identify like elements, and in which:

FIG. 1 is a diagrammatic plan view illustrating a single production plant, which includes a plurality of assembly lines, which further includes a plurality of manufacturing equipment, and which in turn includes a plurality of sub-equipment;

FIG. 2 is a diagrammatic view illustrating the architecture of a system in accordance with the present invention;

FIG. 3A is a pictorial representation illustrating an example of a machine used to transfer initial or intermediary products of an assembly line;

FIG. 3B is a pictorial representation illustrating an example of a machine used to change or modify the initial or intermediary products;

FIG. 4 is a flow chart illustrating the different steps utilized by the methods of the present invention;

FIG. 5 is a block diagram illustrating how a user at a personal computer or terminal would interact with the system;

FIG. 6 illustrates an initial screen presented by the web-browser when a user logs onto the system;

FIG. 7 illustrates a representative format for an efficiency report of weekly waste performance generated by the system and methods of the present invention in both tabular and trendline format;

FIG. 8 illustrates a representative format for an efficiency report that summarizes performance and that provides downtime details for a particular production line over the period of several days; and

FIG. 9 illustrates a representative format for an efficiency report off downtime for a particular machine or component of a production line over a period of weeks based upon the categories or “keys” associated with the data.

### DESCRIPTION OF THE PREFERRED EMBODIMENT

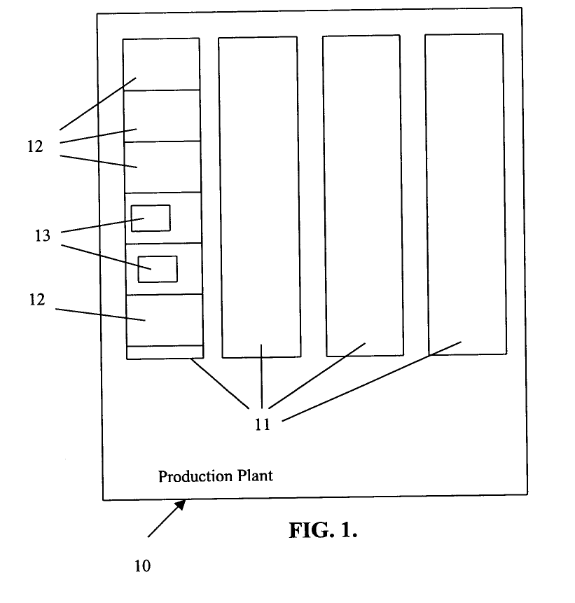

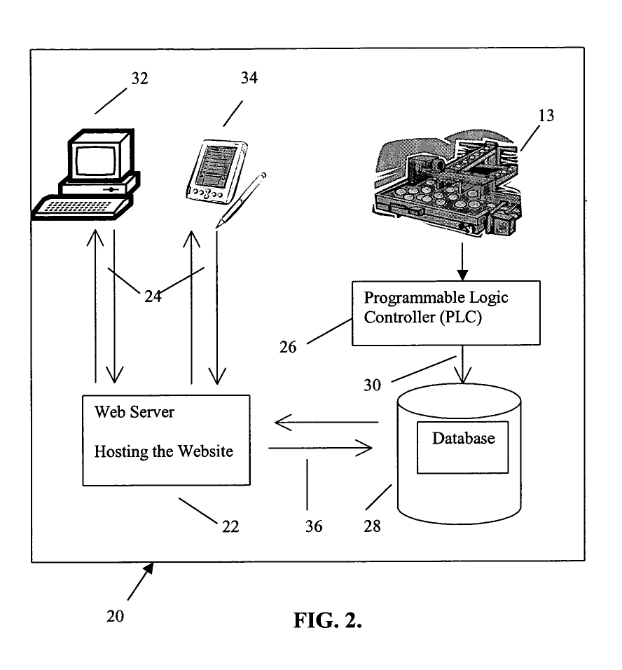

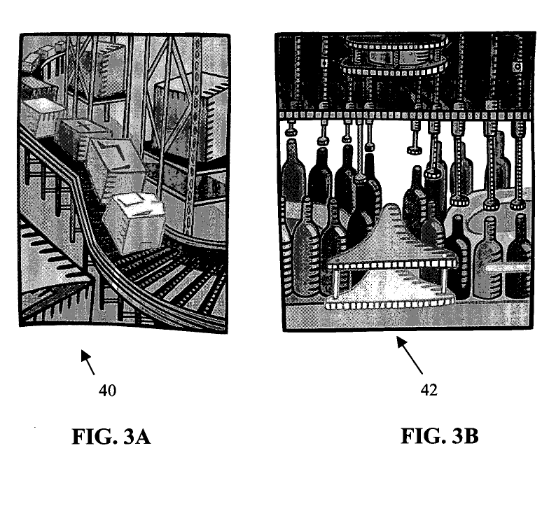

The present invention of a monitoring system, generally designated 20, is shown in FIG. 2. This monitoring system is a distributed computing system that gathers data from the components of an assembly line 13 and then uses that data to calculate the efficiencies. With reference to FIG. 1, a typical assembly line 11 is composed of two different components or types of machines 12. As seen in FIG. 3A and 3B, the first type of machine 40 is a machine that transfers the initial or intermediary products from one point to another. The other type of machine 42 performs a specific task of changing the initial or intermediary products to create the final product. Both types of machines are usually composed of sub-equipment 13 that performs a sub-process or sub-step of the main task. This invention can monitor the sub-equipment 13 of a plurality of machines or equipment 12 that compose a plurality of assembly lines 11, which may compose a plurality of production plants 10.

Referring to the FIGS. 2, 4 and 5, data on the state of the sub-equipment, unit outputs, actual output, capable rate, downtime duration, and reasons for the downtime is gathered at block 50 in one of three ways. With reference to FIG. 2, first, the data is gathered by using a PLC (Programmable Logic Controller) 26, or other digital monitoring device that automatically monitors the equipment, machine, or its sub-equipment. These devices then relay in real-time the current state of the component or its sub-equipment and other data to the database by means of an Ethernet or local network 30. Secondly, an operator can enter data into a terminal or personal computer 32 or handheld device 34 in real-time as the state of the component or sub-equipment 13 changes. Lastly, an operator can batch enter several sets of data for one or more machines or for a plurality of sub-equipment using a single personal computer or terminal 32, or handheld device 34.

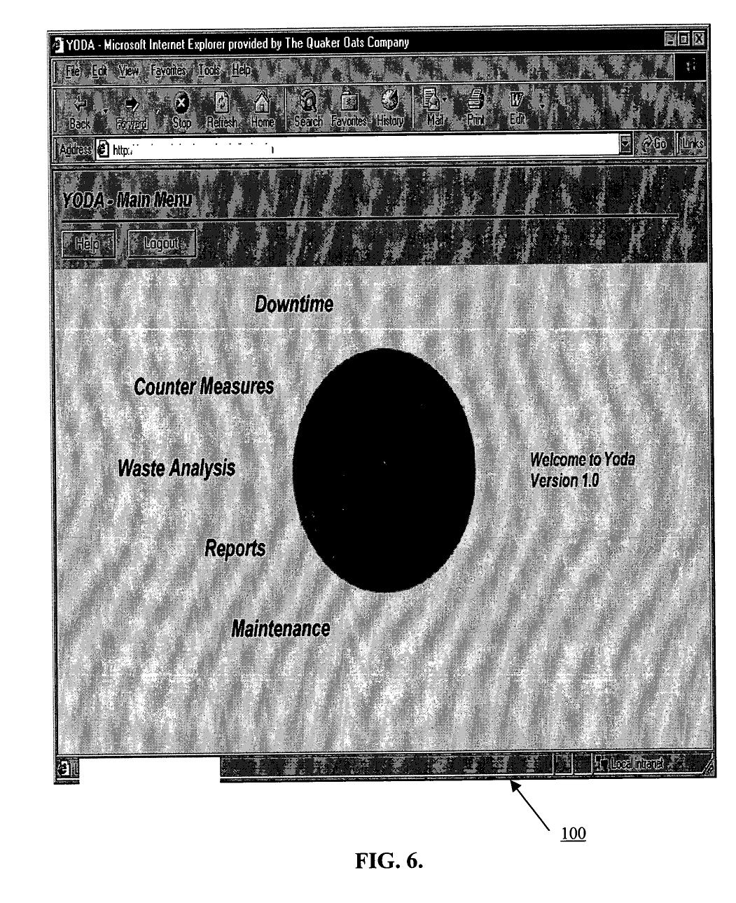

In the preferred embodiment, the last two methods of entry are accomplished by using the Internet or an intranet 24 to a website hosted by another server or computer 22. In general, server or computer 22 may be any type of suitable data processor. The operator or user connects to the website using web browser and the Internet or an intranet 24. Once connected the user then selects one of the options on the main screen 100, as shown FIG. 6, such as the Downtime option. When the operator enters the data by means of the website, the website transfers 36 that data through the web-server to the database 28. However, other embodiments include the ability to enter the data into a handheld device 34, such as a personal digital assistant (PDA) are also feasible.

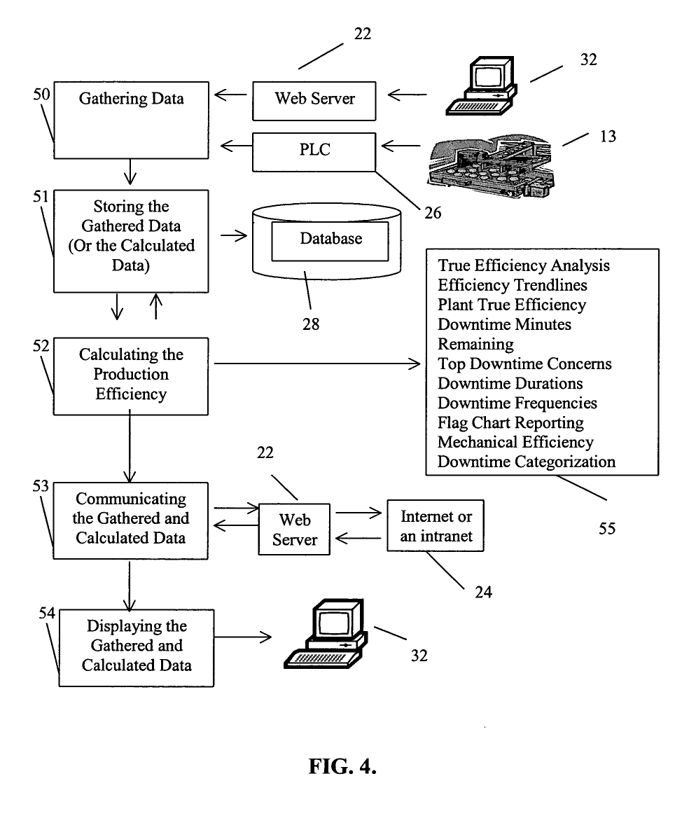

In accordance with block 51 in FIG. 4, the gathered data is stored in the database 28. The database may also organize the information gathered from the PLCs 26 or the web-server 22. In the preferred embodiment the PLCs 26 and the web-server 22 are linked to a centralized Oracle™ database 28. However, the database could be implemented in many different ways. This database then stores the data and the data's respective “keys.” These “keys” are additional information that is provided at the time of entry by the web-server 22, the operator at a terminal or PC 32, or the PLC 26. For example, a “key” could store the location of the equipment or sub-equipment, the type of equipment, status of the equipment or sub-equipment, date of the entry, effective start date, or any other identifying characteristic of the data. A computer, such as a web-server 22 or the database 28, can then sort and rearrange the data entries by these “keys” or only provide the data from the database to a corresponding requested for the data associated with specific “keys” or identifiers.

Once the data is stored in the database, the data can be used to calculate, as indicated at block 52, one or more of the production efficiencies that are identified in block 55. In the preferred embodiment, the production efficiencies are determined from a group of mathematical calculations that determine specific information related to efficiency, such as efficiency trends, true efficiency analysis, plant true efficiency, downtime minutes remaining, top downtime concerns, downtime durations, downtime frequencies, flag chart reporting, waste analysis, minor stop frequency, process upsets and breakdowns. Although in other embodiments, the production efficiency may be any group or subset of equations related to implementing any management initiative program for optimizing the effectiveness of manufacturing equipment. Each of these mathematical calculations may be run individually or concurrently, depending on the results required by the user or computer program. In the preferred embodiment, the web-server 22 contains and implements all the source code required to calculate the individual components of the production efficiency. When an operator or computer user connects to the website and requests the results of a component of the production efficiency, the web-server 22 collects all the needed data from the database 28 by using the corresponding “keys” to the production efficiency component of interest. It then runs the required calculations. Finally, the web-server 22 sends the result back to the operator or computer user's web browser to be displayed in a readable format on the terminal or PC 32 or handheld device 34.

In order to calculate the true efficiency for any assembly line, machine, or sub-equipment the following calculation is used:
(Actual Output/Capable Rate)*(1/Hours scheduled)=True Efficiency.
The actual output is a number of the products or intermediary products that the assembly or its sub-components produce in the number of hours scheduled (the number of hours the assembly line or its sub-component was run). The capable rate is the maximum number of units the assembly line or its sub-components can produce in 1 hour. The actual output and capable rate are both gathered and stored in the database in the same units of measure (cases per hour, 100 pound (CWT) per hour, etc.). The hours scheduled is also gathered by the system and stored in the database. The true efficiency is determined by dividing the actual output by the capable rate and then further dividing the result by the hours scheduled. It is possible to calculate a weekly true efficiency. The ability to calculate a weekly True Efficiency also allows the user or computer to calculate the trendline of the True Efficiency buy taking a standard 13-week average or a 5-week moving average. To calculate the 5-week moving average, a weighted average is taken for each weekly true efficiency of the four previous weeks of operation and the current weekly true efficiency average.

Downtime minutes remaining for any assembly line, machine or sub-equipment is calculated by the following equation:
(1−(Actual Output/Capable Rate/Hours scheduled))*Minutes Ran.
The downtime minutes remaining calculation automatically calculates the number of minutes of idling that the machine or sub-component experienced based on the number of units it produced. The variable minutes ran is gathered by the system and is the total number of minutes in a work shift or the actual elapsed time since the prior output quantity was entered. Downtime minutes is calculated by take the reciprocal of the true efficiency that results in the downtime percentage. The downtime percentage is then multiplied by the Minutes Ran to yield the downtime minutes.

The top downtime concerns calculation is defined as follows:
(Total Downtime Minutes/Total Minutes Scheduled).
This equation is used to determine the top downtime concerns facing an assembly line or plant. The total downtime minutes is the total downtime for all the equipment on an assembly line and is the total idle time of all the equipment due to equipment failure, work stoppage, etc. This is divided by the total number of minutes for all the shifts in the given interval to be measured.

A flag chart report is a report generated by the computer based on the types of downtimes and reasons for the idling of a piece of equipment or sub-equipment. Each downtime reason is grouped by two types: scheduled and unscheduled downtime. The types of downtime are further broken into the following categories: breakdown, changeover, clean-up, heat sterilization, material, meeting, minor stop downtime, planned maintenance, process upset, Quality related (QA) loss, Rate Loss, Start-up, test, Total Productive Manufacturing (TPM) event, and training. The flag chart report uses the following equation to determine the amount of true efficiency loss that has occurred due to each category of downtime: (Total Downtime Minutes by Category/Total Hours Scheduled).

The equation for machine efficiency is:
(Total time−Idle time−Downtime)/(Total time−Idle time).
Total time in this equation is the total amount of time that a piece of equipment or sub-equipment was scheduled to run. The idle time is the amount of time that the piece of equipment or sub-equipment was inactive for a reason other than a breakdown on that piece of equipment. The downtime variable of the equation is the amount of time that the piece of equipment or sub-equipment was inactive for a breakdown on that piece of equipment.

A waste analysis can be preformed by the following equation:
(Product packaged weight/Starting weight).
The product packaged weight is average weight of all the final products produced by an assembly line during a given time interval. The starting weight is the average weight of all the initial or raw materials required to produce one instance of the final product. The resulting ratio from the above equation is the percentage of the raw materials that appear in the final product. The percentage of waste can be found by equation: (1−Product packaged weight/Starting weight).

After calculating the desired production efficiency at block 52 in FIG. 4, the calculated and/or gathered data is communicated at block 53 over the internet or intranet 42 via a web-server 22. The calculated and/or gathered data can also be displayed at block 54 by means of an Internet/intranet website host such as at any computer 32 within the system that may be accessed by way of the Internet or an intranet 24 from computer or network terminal 32 or a handheld device 34. This website offers several features and methods for calculating the production efficiency and related data. For example, the website allows for the user to view all the database entries for the downtime of a specific assembly line, regardless of method used to gather that data. The user can then view graphs and tables of the production efficiency, the components of the production efficiency, or the results of those calculations for each piece of equipment or machine 12 or sub-equipment 13 for any assembly line 11 which is either currently connected and monitored by the system 20 or has data stored in the system 20.

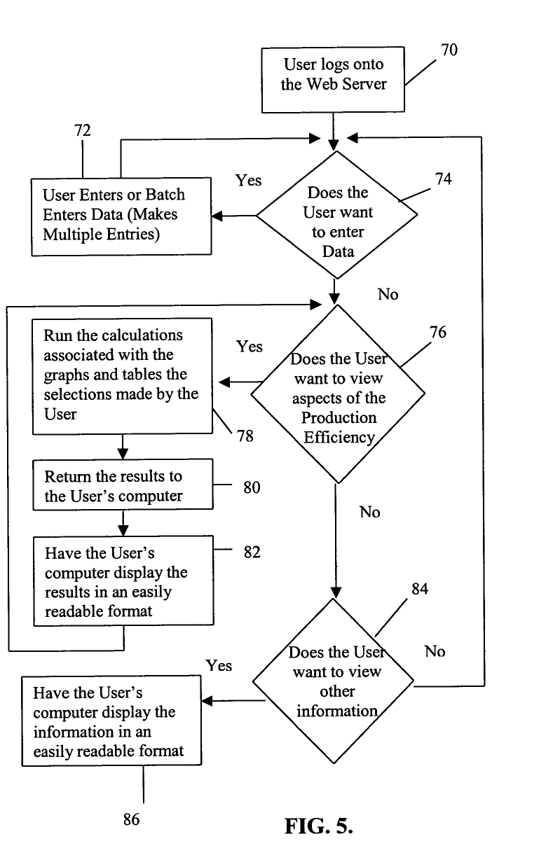

FIG. 5 demonstrates how a user would interact with the website hosted by the web-server 22. First, the user can decide to enter data pertaining to the efficiency of one or more pieces or equipment or sub-equipment at decision block 74. After entering a single instance of data or enter batch entering several sets of data at block 72, the user can continue to enter data or select view different aspects of the production efficiency at block 76. In this case, the web-server will gather the appropriate data and run the calculations requested by the user at block 78. Then it will return the results to the user's computer by means of the Internet or intranet at block 80. Finally, the results will be displayed on the user's computer by means of a web-browser at block 82. The last option the user can select is to view other data associated with efficiency and maintenance of manufacturing equipment at decision block 84. The web-server will then select the appropriate data from the database and return the data to the user's computer to be displayed in an easily readable format by the computer's web-browser at block 86.

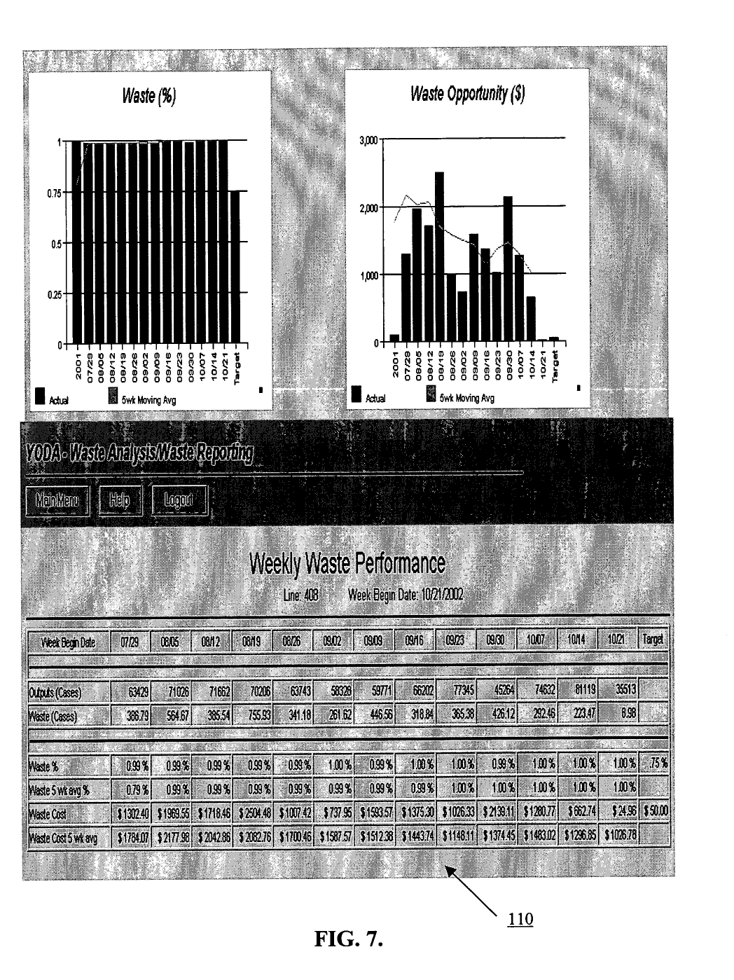

FIGS. 7, 8 and 9 are representative pages or reports created by the web-server 22 based on the gathered input or input stored in the database 28. For example, in the page of FIG. 7, an exemplary waste analysis and waste report is illustrated. This report displays the percent of waste in a bar chart for a five week moving average, along with a target or goal percentage. The waste opportunity in terms of dollars for a five week moving average is also shown in bar graph format. The waste is also numerically illustrated in tabular format, such as, for each week, including the output, the amount of waste, the waste in percent, the waste in percent for a five week moving average, the waste cost and the waste cost in terms of a five week average.

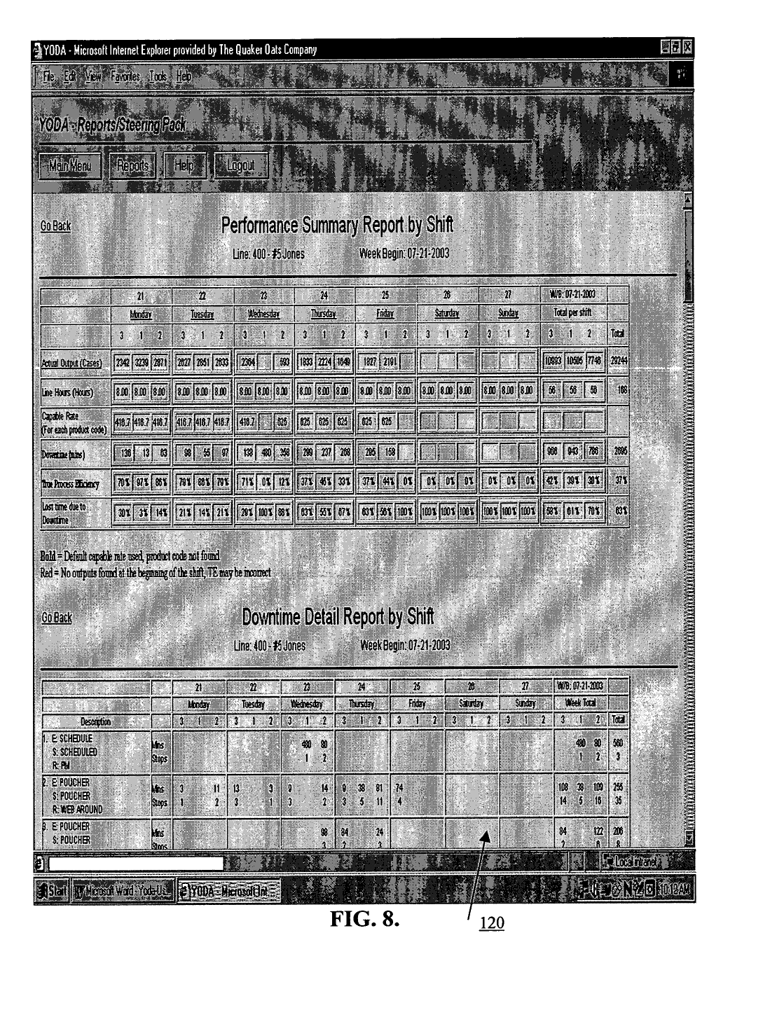

FIG. 8 illustrates a performance summary by shift in numerical tabular format. In this example, the report focuses on a particular line within the factory. The table of FIG. 8 shows the actual output, the hours that the line is operating, the capable rate of the line, the downtime in minutes, the true process efficiency and the time lost to downtime for each of the shifts (1, 2 and 3) and for each day that the line is operating for that week. The report of FIG. 8 also provides a separate downtime detail report by shift, including the total minute of downtime and the number of times that the line was down for each shift.

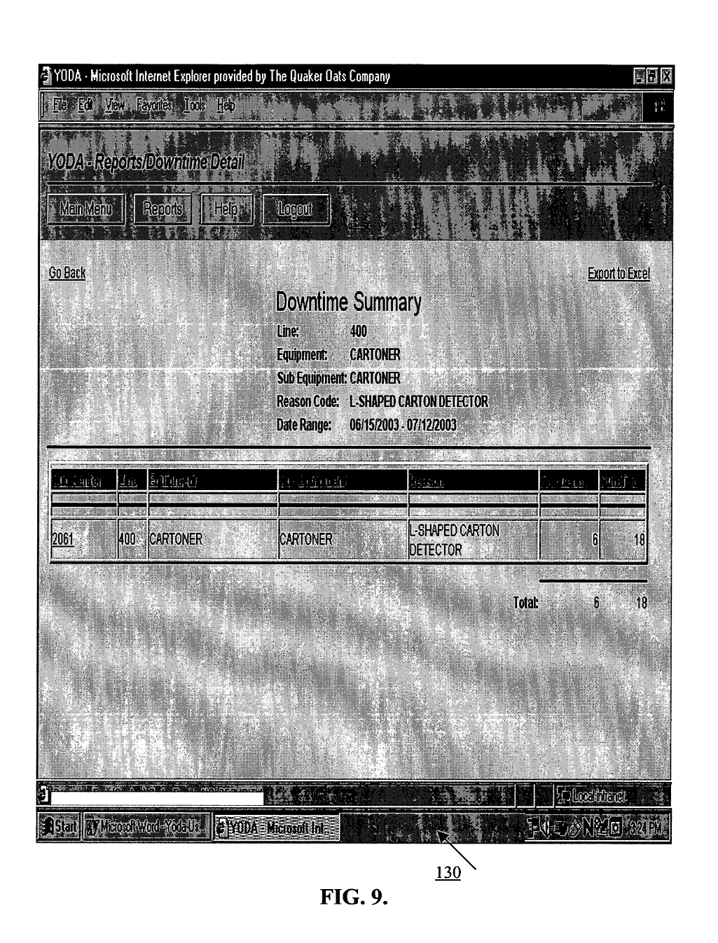

The report 130 shown in FIG. 9 illustrates a representative downtime detail report for a particular piece of equipment on a production line. This report indicates that a cartoner on a line 400 was down 6 times for a total of 18 minutes over a four week period. It also indicates the reason for the downtime, which in this example is due to an L-shaped carton detector.

It will be appreciated that FIGS. 7, 8 and 9 are only exemplary pages or reports, and the web-server 22 or computer 32 modifies the information, tables, graphs, data, and how information is displayed based on what the user requests, what data is available, what search parameters are, the calculations used, and the format the user desires. The web-server 22 then sends these pages or reports over the Internet or an intranet 24 to a computer or terminal 32 in a form interpretable by a web-browser or similar software. Finally, pages or reports similar to the representations in FIGS. 7, 8, and 9 are displayed on the display device of a computer or terminal 32 or a handheld device 34 by a web-browser or similar software.

While particular embodiments of the invention have been shown and described, it will be obvious to those skilled in the art that changes and modifications may be made therein without departing from the invention in its broader aspects.

1. A manufacturing monitoring system used to determine the efficiency of a production plant, an assembly or a process line or the components of that assembly or a process line, comprising:
means for gathering data relating to the efficiency of the production plant, the assembly line or the components of the assembly line,
said data being selected from the group consisting of unit output values, downtime occurrences, downtime duration, downtime incident codes, downtime categorization, action items, minutes ran, hours scheduled, capable rate, actual output, idle time, total time, waste analysis values, or combinations thereof;
means for storing the gathered data;
means for calculating production efficiency based on the gathered data to provide calculated data;
means for communicating the gathered data and the calculated data within said system; and
means for displaying the calculated data.

2. The manufacturing monitoring system in accordance with claim 1 further comprising:
means for displaying the gathered data.

3. The manufacturing monitoring system in accordance with claim 1 further comprising:
means for storing the calculated data.

4. The manufacturing monitoring system in accordance with claim 1 wherein
said means for gathering data is circuitry that monitors the condition and operation of an assembly or a process line component or subcomponent.

5. The manufacturing monitoring system in accordance with claim 4 wherein
said circuitry used to monitor the condition and operation of an assembly or a process line component or subcomponent is a programmable logic controller.

6. The manufacturing monitoring system in accordance with claim 1 wherein
said means for gathering data is an input device capable of sending or receiving data selected from the group consisting of an electronic terminal, a personal computer, a computer, a data processor, a handheld data device, or combinations thereof.

7. The manufacturing monitoring system in accordance with claim 6 wherein
said means for gathering data is an input device for sending or receiving data and which allows the operator to batch enter the data.

8. The manufacturing monitoring system in accordance with claim 1 wherein
said means for calculating production efficiency is a data processor.

9. The manufacturing monitoring system in accordance with claim 1 wherein
said means for storing the gathered data is a database.

10. The manufacturing monitoring system in accordance with claim 1 wherein
said means to communicate the information includes the Internet or an intranet.

11. The manufacturing monitoring system in accordance with claim 1 wherein
said means to display the information includes a terminal, computer, handheld device, monitor or other humanly perceptible display.

12. The manufacturing monitoring system in accordance with claim 1 wherein
said calculated data provides an efficiency report.

13. A manufacturing monitoring system used to determine the efficiency of a production plant, an assembly or a process line or the components of that assembly or a process line, comprising:
data circuitry to gather data relating to the efficiency of the production plant, the assembly line or the components of the assembly line,
said gathered data being selected from the group consisting of unit output values, downtime occurrences, downtime duration, downtime incident codes, downtime categorization, action items, minutes ran, hours scheduled, capable rate, actual output, idle time, total time, waste analysis values, or combinations thereof;
a data processor for receiving the gathered data and for performing calculations with at least some of the gathered data to provide calculated data; and
a display in communication with the data processor to display the calculated data.

14. The manufacturing monitoring system in accordance with claim 13 further comprising:
a database in communication with the data processor for receiving and storing the calculated data.

15. The manufacturing monitoring system in accordance with claim 13 wherein
the calculated data provides an efficiency report.

16. The manufacturing monitoring system in accordance with claim 13 wherein
said data circuitry monitors the condition and operation of an assembly or process line component or subcomponent.

17. The manufacturing monitoring system in accordance with claim 16 wherein
said data circuitry is a programmable logic controller.

18. The manufacturing monitoring system in accordance with claim 13 wherein
said data processor is an electronic terminal, a personal computer, a computer, a handheld computing device, or combinations thereof.

19. The manufacturing monitoring system in accordance with claim 13 wherein
said data circuitry is an input device which allows the operator to batch enter the gathered data.

20. The manufacturing monitoring system in accordance with claim 13 wherein
said gathered data are communicated over the Internet or an intranet.

21. The manufacturing monitoring system in accordance with claim 13 wherein
said display for displaying the gathered data or the calculated data is a part of a computer terminal, a personal computer, a handheld data device, or a monitor.

22. A manufacturing monitoring system used to determine the efficiency of a production plant, an assembly or a process line or the components of that assembly or a process line comprising:
an input layer to gather data relating to the efficiency of the production plant, the assembly line or the components of the assembly line,
said data being selected from the group consisting of unit output values, downtime occurrences, downtime duration, downtime incident codes, downtime categorization, action items, minutes ran, hours scheduled, capable rate, actual output, idle time, total time, waste analysis values, or combinations thereof;
a data processing layer to calculate the production efficiency based on the said data gathered by the input layer;
a storage layer for storing the data gathered by the input layer and for storing the data calculated by the data processing layer;
a communication layer to communicate the data stored at the storage layer within the manufacturing monitoring system; and
a presentation layer to display the data stored at the storage layer.

23. A manufacturing monitoring method for determining the efficiency of a production plant, an assembly or a process line or the components of that assembly or a process line; said method comprising the steps of:
gathering data related to the efficiency of the production plant, the assembly line or the components of the assembly line;
selecting said gathered data from the group consisting of unit output values, downtime occurrences, downtime duration, downtime incident codes, downtime categorization, action items, minutes ran, hours scheduled, capable rate, actual output, idle time, total time, waste analysis values, or combinations thereof;
calculating a production efficiency based on the gathered data with a data processor;
storing the gathered data and the calculated data in a memory;
communicating the gathered data and the calculated data to other computers, terminals, servers, or databases; and
displaying the calculated data on a display.

24. The method of determining the efficiency of a production plant, an assembly or a process line or the components of that assembly or a process line as claimed in claim 23, further comprising the additional step of:
displaying the gathered data on a display.

25. The method of determining the efficiency of a production plant, an assembly or a process line or the components of that assembly or a process line as claimed in claim 23, further comprising the additional step of:
communicating the calculated data over the Internet or an intranet.

26. The method of determining the efficiency of a production plant, an assembly or a process line or the components of that assembly or a process line as claimed in claim 23, further comprising the additional step of:
communicating the gathered data over the Internet or an intranet.

27. The method of determining the efficiency of a production plant, an assembly or a process line or the components of that assembly or a process line as claimed in claim 23, further comprising the additional step of:
storing the gathered data in a database.

28. The method of determining the efficiency of a production plant, an assembly or a process line or the components of that assembly or a process line as claimed in claim 23, further comprising the additional step of:
displaying the calculated data in a format viewable by a web-browser.

29. The method of determining the efficiency of a production plant, an assembly or a process line or the components of that assembly or a process line as claimed in claim 23,
wherein the step of calculating a production efficiency provides an efficiency report.

30. The method of determining the efficiency of a production plant, an assembly or a process line or the components of that assembly or a process line as claimed in claim 23, further comprising the additional step of:
entering gathered data by batch entry into said system.

31. The method of determining the efficiency of a production plant, an assembly or a process line or the components of that assembly or a process line as claimed in claim 23, further comprising the additional step of:
communicating the calculated data over the Internet or an intranet.

32. The method of determining the efficiency of a production plant, an assembly or a process line or the components of that assembly or a process line as claimed in claim 23, wherein
the step of gathering data related to the efficiency of the production plant, the assembly line or the components of the assembly line includes gathering data with a programmable logic controller.

33. The method of determining the efficiency of a production plant, an assembly or a process line or the components of that assembly or a process line as claimed in claim 23, wherein
the step of gathering data related to the efficiency of the production plant, the assembly line or the components of the assembly line includes monitoring the condition or operation of an assembly or a process line component or subcomponent.
